(19) United States
(12) Patent Application Publication
(10) Pub. No.: US 2025/0005509 A1
(43) Pub. Date: Jan. 2, 2025

(54) SYSTEM, METHOD, AND COMPUTER PROGRAM FOR AUTOMATED MANAGEMENT OF ELECTRONIC DEVICE INVENTORY

(71) Applicant: Amdocs Development Limited, Limassol (CY)

(72) Inventors: Eran Yosef Paran, Hod Hasharon (IL); Shmuel Ur, Shorashim (IL); Markus Michael Buchner, Munich (DE)

(21) Appl. No.: 18/214,951

(22) Filed: Jun. 27, 2023

(51) Int. Cl. G06Q 10/087; G06K 7/14; G06V 20/64

(52) U.S. Cl. CPC G06Q 10/087; G06K 7/1417; G06V 20/64

(57) ABSTRACT

As described herein, a system, method, and computer program are provided for providing automated management of electronic device inventory. An electronic device is triggered to emit at least one signal capable of being sensed by at least one sensor. The at least one signal emitted by the electronic device is sensed, using the at least one sensor. A physical location of the electronic device is determined, based on the sensed at least one signal. A discrepancy between the physical location of the electronic device and a specified location of the electronic device recorded in an inventory management system is detected. At least one action is performed to handle the discrepancy.

### FIELD OF THE INVENTION

The present invention relates to inventory management systems.

### BACKGROUND

In general, inventory management systems are computer-based systems that are configured to track the inventory of some product. In particular, some uses of inventory management systems include tracking specifically the physical location of electronic devices operated by an entity, such as network devices physically put into a server room or other network room for the purpose of providing electronic storage, processing, networking, etc. capabilities. However, to date, inventory management systems are required to be manually updated with location information whenever an electronic device is re-located (e.g. to a new room, isle, rack, shelf, etc.).

As a result of human error, an inventory management system may not reflect the actual electronic device locations, thus creating misalignment between the actual electronic device locations and the location information that is recorded in the inventory management system. For example, ad-hoc changes, unplanned changes, and emergency-type re-locations are typically lacking the post-action documentation of the change in the inventory management system, and thus are often responsible for creating discrepancies between the physical world of electronic device positioning and the location information that is recorded in the inventory management system. Inaccurate tracking of electronic device locations creates an incorrect presentation of available space to allocate new electronic devices (e.g. servers and network devices), which impacts optimized space planning and placement, optimized heat dissipation, and more.

There is thus a need for addressing these and/or other issues associated with the prior art. For example, there is a need for providing automated management of electronic device inventory.

### SUMMARY

As described herein, a system, method, and computer program are provided for providing automated management of electronic device inventory. In an embodiment, an electronic device is triggered to emit at least one signal capable of being sensed by at least one sensor. The at least one signal emitted by the electronic device is sensed, using the at least one sensor. A physical location of the electronic device is determined, based on the sensed at least one signal. A discrepancy between the physical location of the electronic device and a specified location of the electronic device recorded in an inventory management system is detected. At least one action is performed to handle the discrepancy.

In another embodiment, a specified location of an electronic device recorded in an inventory management system is identified. A discrepancy between a physical location of the electronic device and the specified location of the electronic device recorded in the inventory management system is detected, using a camera that senses electronic device identifying characteristics. At least one action is performed to handle the discrepancy.

### BRIEF DESCRIPTION OF THE DRAWINGS

FIG. 1 illustrates a method for providing automated management of electronic device inventory, in accordance with one embodiment.

FIG. 2 illustrates a system having a single sensor for providing automated management of electronic device inventory, in accordance with one embodiment.

FIG. 3 illustrates a system having a plurality of sensors for providing automated management of electronic device inventory, in accordance with one embodiment.

FIG. 4 illustrates a method for using a camera to provide automated management of electronic device inventory, in accordance with one embodiment.

FIG. 5 illustrates a network architecture, in accordance with one possible embodiment.

FIG. 6 illustrates an exemplary system, in accordance with one embodiment.

### DETAILED DESCRIPTION

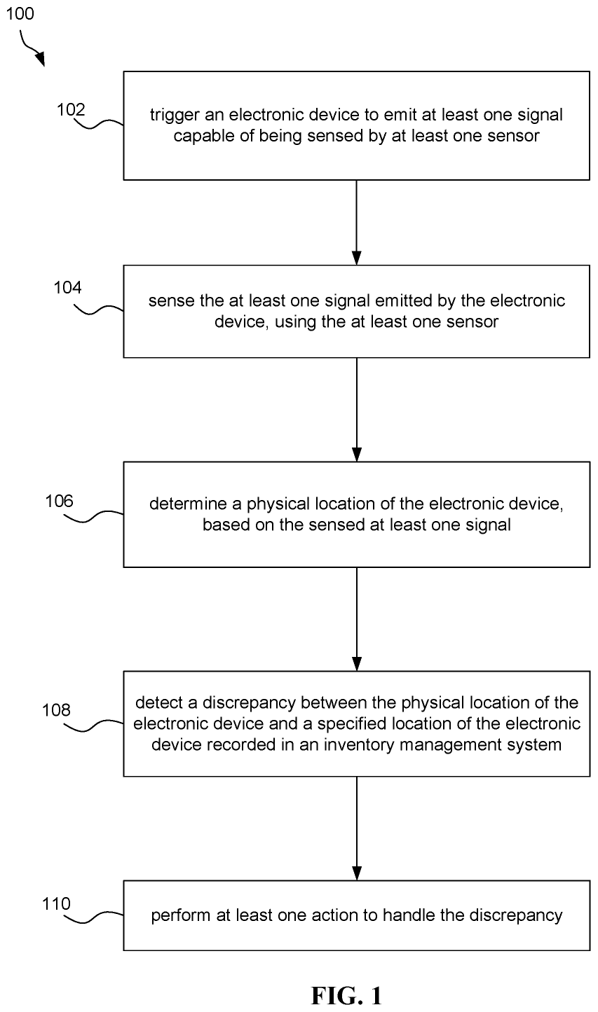

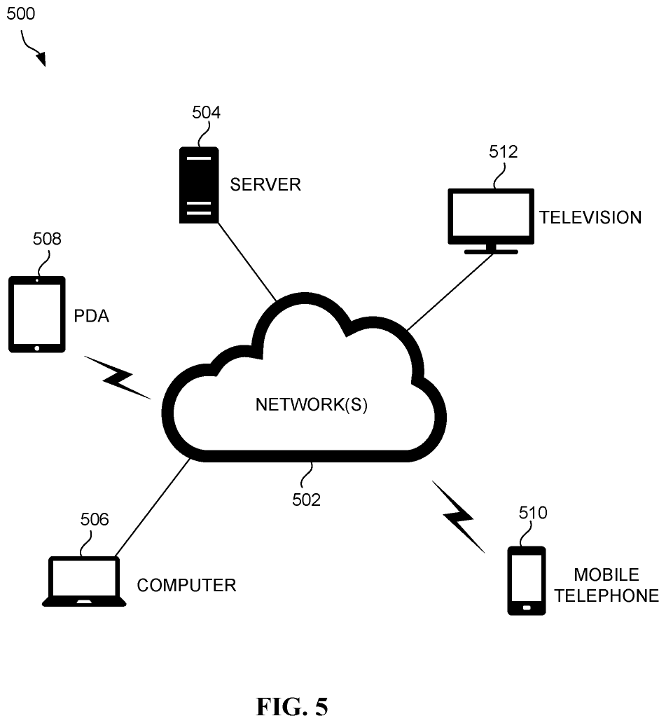

FIG. 1 illustrates a method 100 for providing automated management of electronic device inventory, in accordance with one embodiment. The method 100 may be carried out by a computer system, such as that described below with respect to FIGS. 5 and/or 6. In an embodiment, the computer system may implement an inventory management system for use in managing locations of electronic devices. In another embodiment, the computer system may interface (e.g. via a network) the inventory management system, which may be located on a remote computer system. In an embodiment, the computer system also interface (e.g. via a network) one or more electronic devices that are part of the inventory to be managed, including the electronic device described herein.

In operation 102, an electronic device is triggered to emit at least one signal capable of being sensed by at least one sensor. With respect to the present description, the electronic device refers to any device that is electronically operated to at least emit a signal when triggered. Accordingly, the electronic device is configured to be triggered in some manner to emit a signal, and to emit the signal in response to being triggered to do so. In other words, the electronic device is caused to emit the signal. In an embodiment, the electronic device may be triggered to emit the signal by sending a command to the electronic device instructing the electronic device to emit the signal (e.g. in a particular pattern, etc.), which may in turn create a workload on the electronic device to emit the signal as commanded.

In an embodiment, the electronic device is a computing device. For example, the computing device may be a server. As another example, the computing device may be a network device (e.g. a router, card, etc.). To this end, the electronic device will be configured to perform functionality other than emitting signal(s) when triggered, such as computer processing tasks, networking tasks, etc.

It should be noted that the signal(s) emitted by the electronic device may be any type of signal capable of being sensed by a respective sensor. In an embodiment, each signal may be emitted via an output of the electronic device. In various examples, the signal(s) may include any combination of: a light (e.g. capable of being sensed by a camera sensor), a sound (e.g. capable of being sensed by a microphone sensor), heat (e.g. capable of being sensed by a thermal sensor), a wireless communication (e.g. with media access control address (MAC) address (e.g. capable of being sensed by a communication device such as a Bluetooth enabled device), etc. In an embodiment, the signal(s) may each be triggered to be output in a defined pattern, such as a blinking a light in a particular pattern, outputting a particular pattern of audio sounds, generating a particular pattern of heat, etc.

In an embodiment, the electronic device may be triggered to emit a single signal capable of being sensed by a single sensor. In another embodiment, the electronic device may be triggered to emit a plurality of different signals capable of being sensed by a plurality of different sensors. Further with respect to this embodiment, the electronic device may be triggered to emit the plurality of different signals in a defined sequence (e.g. per one or more defined rules).

In operation 104, the at least one signal emitted by the electronic device is sensed, using the at least one sensor. The sensor refers to any device configured to sense a particular type of signal output by one or more electronic devices. As mentioned above, each sensor may be a camera, microphone, thermal gauge, etc. Thus, a certain type of signal emitted by the electronic device will be sensed by a respective sensor configured to sense that type of signal. In the present embodiment, a signal emitted by the electronic device is sensed when the electronic device is within a defined vicinity of the respective sensor (i.e. within the range for which the sensor is designed to sense signals). In an optional embodiment, each sensor can be stationary, or placed on an automated guided vehicle (AVG) (e.g. with its location tracked).

In operation 106, a physical location of the electronic device is determined, based on the sensed at least one signal. The physical location of the electronic device refers to a geographical placement of the electronic device. For example, the physical location may be determined as a particular building, a particular room, a particular rack, a particular shelf, etc.

In an embodiment, the physical location of the electronic device is determined by processing the signal(s) emitted by the electronic device that have been sensed. The physical location may be determined as a function of a strength of the sensed signal and a location of the sensor, in an embodiment. In another embodiment, the physical location may be determined by processing the sensed at least one signal using a machine learning model (e.g. that has been trained to determine physical location of an electronic device based on one or more input signals).

In operation 108, a discrepancy between the physical location of the electronic device and a specified location of the electronic device recorded in an inventory management system is detected. The discrepancy refers to any difference between the physical location of the electronic device, as determined in operation 106, and a specified location of the electronic device that is recorded in an inventory management system. The specified location may have been recorded in the inventory management system manually by a user or during a prior performed iteration of the method 100.

In operation 110, at least one action is performed to handle the discrepancy. The action(s) may be predefined via one or more policies created for managing inventory in the inventory management system. In an embodiment, the action may include automatically recording the physical location of the electronic device in the inventory management system (e.g. updating the inventory management system to indicate the physical location of the electronic device). In another embodiment, the action may include generating a notification of the discrepancy for a user, which for example may prompt the user to record the physical location of the electronic device in the inventory management system or to re-locate the electronic device back to the specified location that is recorded in the inventory management system.

To this end, the method 100 may be performed to provide automated management of an electronic device inventory in an inventory management system, namely by automating the detection of the physical location of an electronic device via one or more sensors, and then by taking action when there is any discrepancy between the physical location and a prior recorded location of the electronic device in the inventory management system. The action, such as automatically recording the physical location of an electronic device in the inventory management system, may ensure that the inventory is up-to-date, which is critical for planning decisions which require that whatever electronic devices are installed are represented correctly in the inventory.

In another possible implementation of the method 100, the electronic device may be triggered to emit the at least one signal capable of being sensed by at least one sensor (operation 102), however, it may be determined that the at least one signal emitted by the electronic device is not sensed by the at least one sensor. For example, the at least one sensor that is activated to sense the at least one signal may be positioned within a detection range of an expected location of the electronic device (i.e. as specified in the inventory management system). Thus, the at least one sensor may be out of a range of the electronic device. In this case, a discrepancy may be detected between a physical location of the electronic device (which may be unknown, since the signal has not been sensed) and the specified location of the electronic device recorded in the inventory management system. Per operation 110, the at least one action may then be performed to handle the discrepancy.

It should be noted that the method 100 may be performed periodically, for each known electronic device (e.g. registered in the inventory management system). In another embodiment, the method 100 may be performed with respect to a particular electronic device before a physical action is to be taken with respect to that particular electronic device (e.g. to make sure a person is guided to the correct room/place at which the particular electronic device is currently located). In another embodiment, the method 100 may be triggered based upon the inventory. Further to this embodiment, the method 100 may be performed in near-real time after a change is recorded in the inventory management system. For example, when a change in location of a particular electronic device is recorded in the inventory management system, then the method 100 may be triggered for that particular electronic device (e.g. to validate that the electronic device was re-located correctly in accordance with the recorded change, and to perform a corrective action when the re-location is not validated).

In a further possible embodiment, the machine learning model mentioned above may also be trained to determine available space for locating a given electronic device, based on current physical locations of electronic devices in a given area (e.g. room, isle, rack, shelf, etc.). The available space may be determined based on unoccupied space, space requirements for the given electronic device, other electronic devices around the available space, etc. Thus, as an option, the machine learning model may further process the sensed signal(s) to determine availability of space for locating one or more additional electronic devices. In yet another possible embodiment, the determined availability of space for locating one or more additional electronic devices may be recorded in the inventory management system, as well as an activation status of the electronic devices.

More illustrative information will now be set forth regarding various optional architectures and uses in which the foregoing method may or may not be implemented, per the desires of the user. It should be strongly noted that the following information is set forth for illustrative purposes and should not be construed as limiting in any manner. Any of the following features may be optionally incorporated with or without the exclusion of other features described.

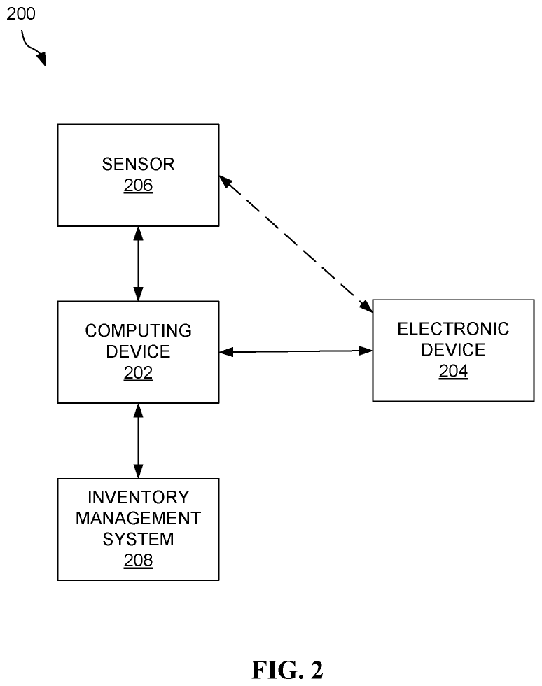

FIG. 2 illustrates a system 200 having a single sensor for providing automated management of electronic device inventory, in accordance with one embodiment. As an option, the system 200 may be implemented in the context of the details of the previous figure and/or any subsequent figure(s). Of course, however, the system 200 may be implemented in the context of any desired environment. Further, the aforementioned definitions may equally apply to the description below.

As shown, the system 200 includes a computing device 202 that interfaces an electronic device 204. The computing device 202 triggers the electronic device 204 to emit a signal capable of being sensed by a sensor 206. In response to the trigger, the electronic device 204 emits the signal. In an embodiment, the electronic device 204 may be triggered to emit the signal in a defined pattern.

In response to the signal being emitted, the sensor 206 senses the signal. Information associated with the sensed signal is provided by the sensor 206 to the computing device 202. The computing device 202 then processes the information (e.g. using a machine learning model) to determine a physical location of the electronic device 204.

The computing device 202 also interfaces an inventory management system 208. The computing device 202 reads a specified location of the electronic device 204 that has been recorded in the inventory management system 208. The computing device 202 then determines whether there is a discrepancy between the physical location that has been determined for the electronic device 204 and the specified location of the electronic device 204 that is currently recorded in the inventory management system 208.

When the discrepancy is found by the computing device 202, the computing device 202 may not take any action. However, when the discrepancy is found by the computing device 202, the computing device 202 automatically performs at least one action to handle the discrepancy.

### Signal Pattern

In an embodiment, the computing device 202 may trigger the electronic device 204 to emit the signal with a defined pattern. This trigger may create a workload on the electronic device 204 that creates a specific pattern for the signal (e.g. audio, thermal, etc.). For example, a workload may make the electronic device 204 warmer for a first period of time, and then subsequently allows the electronic device 204 to cool for a second period of time, thereby creating a thermal pattern. As another example, the workload may make the electronic device 204 run its disk on and off, thereby creating a unique recognizable audible pattern. As yet another example, the workload may make the electronic device 204 emit light according to an on/off pattern—and in this case even if the light is not seen directly from the camera sensor, a change in an amount of light (e.g. via reflections) in a vicinity of the camera sensor may be sensed according to the pattern.

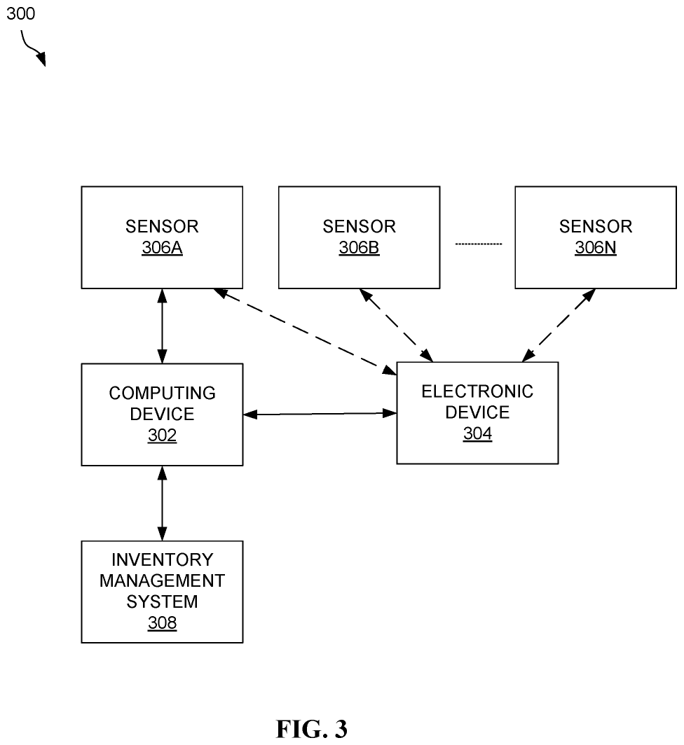

FIG. 3 illustrates a system 300 having a plurality of sensors for providing automated management of electronic device inventory, in accordance with one embodiment. As an option, the system 300 may be implemented in the context of the details of the previous figure and/or any subsequent figure(s). Of course, however, the system 300 may be implemented in the context of any desired environment. Further, the aforementioned definitions may equally apply to the description below.

The system 300 is configured to operate similar to the system 200 of FIG. 2, except that the computing device 302 triggers the electronic device 304 to emit a plurality of signals capable of being sensed by a plurality of sensors 306A-N. In response to the trigger, the electronic device 304 emits the signals. In an embodiment, the electronic device 304 may be triggered to emit the plurality of signals in a defined sequence.

In response to the signals being emitted, the sensors 306A-N each sense a respective one of the signals. Information associated with the sensed signals is provided by the sensors 306A-N to the computing device 302. The computing device 302 then processes the information (e.g. using a machine learning model) to determine a physical location of the electronic device 304.

### Distributed Sensors

In one exemplary embodiment, the sensors 306A-N may be distributed to different areas (e.g. of a building, a room, etc.). In an embodiment, the electronic device 304 may be triggered to emit the signals in a defined sequence, which may be configured based on the location of the sensors 306A-N. For example, triggering the electronic device 304 to emit a plurality of different signals may include: triggering the electronic device 304 to emit a first signal capable of being sensed by a first sensor 306A, and determining whether the first signal emitted by the electronic device 304 has been sensed (e.g, thus indicating whether the electronic device 304 is within the defined vicinity of the first sensor 306A). Triggering the electronic device 304 to emit a plurality of different signals may further include triggering the electronic device 304 to emit a second signal capable of being sensed by a second sensor 306B, when the first signal emitted by the electronic device 304 has been sensed by the first sensor 306A, and triggering the electronic device 304 to emit a third signal capable of being sensed by a third sensor 306C, when the first signal emitted by the electronic device 304 has not been sensed by the first sensor 306A. This exemplary sequence may be used to narrow down a more precise location of the electronic device 304.

The use of multiple sensors 306A-N may improve accuracy of the determination of the physical location of the electronic device 304. In an embodiment, a first signal that can be sensed from larger distance may be relied upon initially to determine a large area in which the electronic device 304 is physically located, and then a second signal that can be sensed from a smaller distance may be relied upon subsequently to narrow down a sub-area of the large area in which the electronic device 304 is physically located. For example, a sound signal may first be used to detect a group of rooms in which the electronic device 304 is physically located (e.g. using a microphone sensor capable of sensing sound signals over the group of the rooms), and then a thermal signal may be subsequently used to determine in which of the rooms the electronic device 304 is physically located (e.g. using a separate thermal sensor situated in each of the rooms in the group).

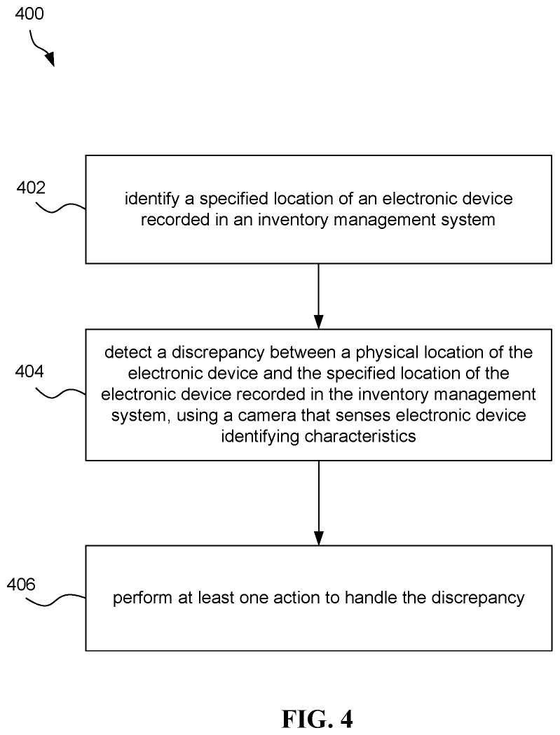

FIG. 4 illustrates a method 400 for using a camera to provide automated management of electronic device inventory, in accordance with one embodiment. The definitions and context of the embodiments described above may equally apply to the present method 400.

In operation 402, a specified location of an electronic device recorded in an inventory management system is identified. In operation 404, a discrepancy between a physical location of the electronic device and the specified location of the electronic device recorded in the inventory management system is detected, using a camera that senses electronic device identifying characteristics. In various examples, the identifying characteristics may be a printed label (e.g. barcode, quick response (QR) code), physical shape, dimensions, color, etc.

In an embodiment, an actual physical location of the electronic device may be determined by using the camera to sense one or more identifying characteristics of the electronic device at the physical location, and then the discrepancy may be detected by determining that the actual physical location is different from the specified location. In another embodiment, it may be determined that a different electronic device is located at the specified location by using the camera to sense one or more identifying characteristics of the different electronic device at the specified location, and then the discrepancy may be detected by determining that it is the different electronic device that is located at the specified location

In operation 406, at least one action is performed to handle the discrepancy.

FIG. 5 illustrates a network architecture 500, in accordance with one possible embodiment. As shown, at least one network 502 is provided. In the context of the present network architecture 500, the network 502 may take any form including, but not limited to a telecommunications network, a local area network (LAN), a wireless network, a wide area network (WAN) such as the Internet, peer-to-peer network, cable network, etc. While only one network is shown, it should be understood that two or more similar or different networks 502 may be provided.

Coupled to the network 502 is a plurality of devices. For example, a server computer 504 and an end user computer 506 may be coupled to the network 502 for communication purposes. Such end user computer 506 may include a desktop computer, lap-top computer, and/or any other type of logic. Still yet, various other devices may be coupled to the network 502 including a personal digital assistant (PDA) device 508, a mobile phone device 510, a television 512, etc.

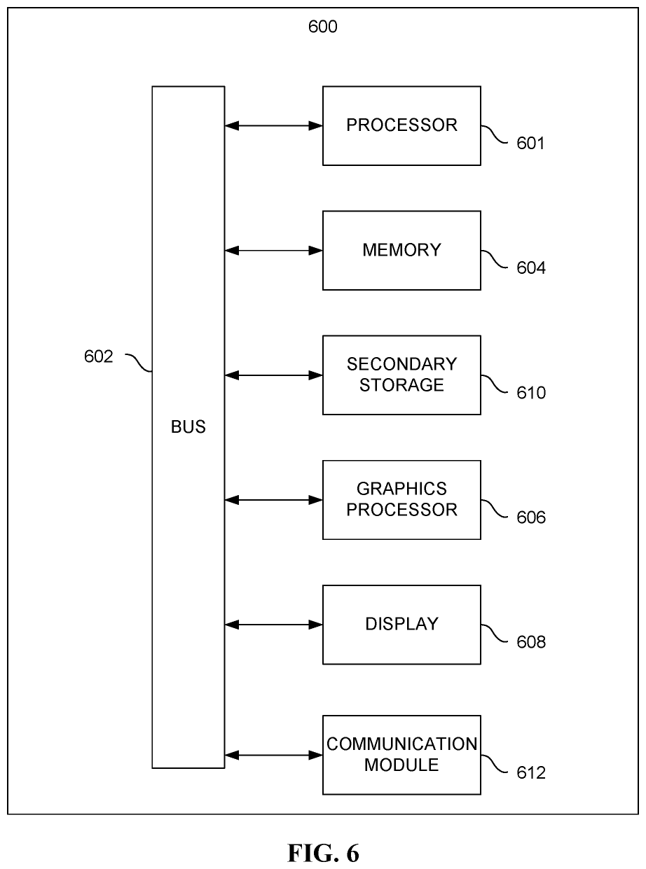

FIG. 6 illustrates an exemplary system 600, in accordance with one embodiment. As an option, the system 600 may be implemented in the context of any of the devices of the network architecture 500 of FIG. 5. Of course, the system 600 may be implemented in any desired environment.

As shown, a system 600 is provided including at least one central processor 601 which is connected to a communication bus 602. The system 600 also includes main memory 604 [e.g. random access memory (RAM), etc.]. The system 600 also includes a graphics processor 606 and a display 608.

The system 600 may also include a secondary storage 610. The secondary storage 610 includes, for example, solid state drive (SSD), flash memory, a removable storage drive, etc. The removable storage drive reads from and/or writes to a removable storage unit in a well-known manner.

Computer programs, or computer control logic algorithms, may be stored in the main memory 604, the secondary storage 610, and/or any other memory, for that matter. Such computer programs, when executed, enable the system 600 to perform various functions (as set forth above, for example). Memory 604, storage 610 and/or any other storage are possible examples of non-transitory computer-readable media.

The system 600 may also include one or more communication modules 612. The communication module 612 may be operable to facilitate communication between the system 600 and one or more networks, and/or with one or more devices through a variety of possible standard or proprietary communication protocols (e.g. via Bluetooth, Near Field Communication (NFC), Cellular communication, etc.).

As used here, a “computer-readable medium” includes one or more of any suitable media for storing the executable instructions of a computer program such that the instruction execution machine, system, apparatus, or device may read (or fetch) the instructions from the computer readable medium and execute the instructions for carrying out the described methods. Suitable storage formats include one or more of an electronic, magnetic, optical, and electromagnetic format. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; and the like.

It should be understood that the arrangement of components illustrated in the Figures described are exemplary and that other arrangements are possible. It should also be understood that the various system components (and means) defined by the claims, described below, and illustrated in the various block diagrams represent logical components in some systems configured according to the subject matter disclosed herein.

For example, one or more of these system components (and means) may be realized, in whole or in part, by at least some of the components illustrated in the arrangements illustrated in the described Figures. In addition, while at least one of these components are implemented at least partially as an electronic hardware component, and therefore constitutes a machine, the other components may be implemented in software that when included in an execution environment constitutes a machine, hardware, or a combination of software and hardware.

More particularly, at least one component defined by the claims is implemented at least partially as an electronic hardware component, such as an instruction execution machine (e.g., a processor-based or processor-containing machine) and/or as specialized circuits or circuitry (e.g., discreet logic gates interconnected to perform a specialized function). Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the description above, the subject matter is described with reference to acts and symbolic representations of operations that are performed by one or more devices, unless indicated otherwise. As such, it will be understood that such acts and operations, which are at times referred to as being computer-executed, include the manipulation by the processor of data in a structured form. This manipulation transforms the data or maintains it at locations in the memory system of the computer, which reconfigures or otherwise alters the operation of the device in a manner well understood by those skilled in the art. The data is maintained at physical locations of the memory as data structures that have particular properties defined by the format of the data. However, while the subject matter is being described in the foregoing context, it is not meant to be limiting as those of skill in the art will appreciate that several of the acts and operations described hereinafter may also be implemented in hardware.

To facilitate an understanding of the subject matter described herein, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

The embodiments described herein included the one or more modes known to the inventor for carrying out the claimed subject matter. Of course, variations of those embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A non-transitory computer-readable media storing computer instructions which when executed by one or more processors of a device cause the device to:
trigger an electronic device to emit at least one signal capable of being sensed by at least one sensor;
sense the at least one signal emitted by the electronic device, using the at least one sensor;
determine a physical location of the electronic device, based on the sensed at least one signal;
detect a discrepancy between the physical location of the electronic device and a specified location of the electronic device recorded in an inventory management system; and
perform at least one action to handle the discrepancy.

2. The non-transitory computer-readable media of claim 1, wherein the electronic device is a computing device.

3. The non-transitory computer-readable media of claim 2, wherein the computing device is a server.

4. The non-transitory computer-readable media of claim 1, wherein the at least one signal is a light.

5. The non-transitory computer-readable media of claim 1, wherein the at least one signal is a sound.

6. The non-transitory computer-readable media of claim 1, wherein the at least one signal is heat.

7. The non-transitory computer-readable media of claim 1, wherein the at least one signal is triggered to be output in a defined pattern.

8. The non-transitory computer-readable media of claim 1, wherein the electronic device is triggered to emit a single signal capable of being sensed by a single sensor.

9. The non-transitory computer-readable media of claim 1, wherein the electronic device is triggered to emit a plurality of different signals capable of being sensed by a plurality of different sensors.

10. The non-transitory computer-readable media of claim 9, wherein the electronic device is triggered to emit the plurality of different signals in a defined sequence.

11. The non-transitory computer-readable media of claim 9, wherein triggering the electronic device to emit the plurality of different signals includes:
triggering the electronic device to emit a first signal capable of being sensed by a first sensor,
determining whether the first signal emitted by the electronic device has been sensed,
triggering the electronic device to emit a second signal capable of being sensed by a second sensor, when the first signal emitted by the electronic device has been sensed, and
triggering the electronic device to emit a third signal capable of being sensed by a third sensor, when the first signal emitted by the electronic device has not been sensed.

12. The non-transitory computer-readable media of claim 1, wherein the at least one sensor is a camera.

13. The non-transitory computer-readable media of claim 1, wherein the at least one sensor is an audio sensor.

14. The non-transitory computer-readable media of claim 1, wherein the at least one sensor is a thermal sensor.

15. The non-transitory computer-readable media of claim 1, wherein the physical location is determined by processing the sensed at least one signal using a machine learning model.

16. The non-transitory computer-readable media of claim 16, wherein the machine learning model further processes the sensed at least one signal to determine availability of space for locating one or more additional electronic devices.

17. The non-transitory computer-readable media of claim 1, wherein the at least one action includes automatically recording the physical location of the electronic device in the inventory management system.

18. The non-transitory computer-readable media of claim 1, wherein the at least one action includes generating a notification of the discrepancy for a user.

19. A method, comprising:
at a computer system:
triggering an electronic device to emit at least one signal capable of being sensed by at least one sensor;
sensing the at least one signal emitted by the electronic device, using the at least one sensor;
determining a physical location of the electronic device, based on the sensed at least one signal;
detecting a discrepancy between the physical location of the electronic device and a specified location of the electronic device recorded in an inventory management system; and
performing at least one action to handle the discrepancy.

20. A system, comprising:
a non-transitory memory storing instructions; and
one or more processors in communication with the non-transitory memory that execute the instructions to:
trigger an electronic device to emit at least one signal capable of being sensed by at least one sensor;
determine that the at least one signal emitted by the electronic device is not sensed by the at least one sensor;
detect a discrepancy between a physical location of the electronic device and a specified location of the electronic device recorded in an inventory management system; and
perform at least one action to handle the discrepancy.

21. A method, comprising:
at a computer system:
identifying a specified location of an electronic device recorded in an inventory management system;
detecting a discrepancy between a physical location of the electronic device and the specified location of the electronic device recorded in the inventory management system, using a camera that senses electronic device identifying characteristics; and
performing at least one action to handle the discrepancy.

22. The method of claim 21, further comprising, at the computer system:
determining an actual physical location of the electronic device by using the camera to sense one or more identifying characteristics of the electronic device at the physical location,
wherein the discrepancy is detected by determining that the actual physical location is different from the specified location.

23. The method of claim 21, further comprising, at the computer system:
determining that a different electronic device is located at the specified location by using the camera to sense one or more identifying characteristics of the different electronic device at the specified location,
wherein the discrepancy is detected by determining that it is the different electronic device that is located at the specified location.

24. The method of claim 21, wherein the electronic device identifying characteristics include a printed label.

25. The method of claim 24, wherein the printed label is a barcode or a quick response (QR) code.

26. The method of claim 21, wherein the electronic device identifying characteristics include at least one of: physical shape, dimensions, or color.
